(19) United States
(12) Patent Application Publication
(10) Pub. No.: US 2022/0302778 A1
(43) Pub. Date: Sep. 22, 2022

(54) ROTOR FOR AN ELECTRIC MACHINE, AND ELECTRIC MACHINE

(71) Applicant: Valeo Siemens eAutomotive Germany GmbH, Erlangen (DE)

(72) Inventor: Boris Dotz, München (DE)

(73) Assignee: Valeo Siemens eAutomotive Germany GmbH, Erlangen (DE)

(21) Appl. No.: 17/638,568

(22) PCT Filed: Aug. 24, 2020
(86) PCT No.: PCT/EP2020/073653

§ 371 Date: Feb. 25, 2022

(30) Foreign Application Priority Data
Aug. 28, 2019 (DE) 10 2019 123 031.4

(51) Int. Cl. H02K 1/276

(52) U.S. Cl. CPC H02K 1/276; H02K 29/03

(57) ABSTRACT

A rotor (1) for an electric machine (16) which has at least two poles and an even number of N≥6 stacked rotor modules (2a-2f), wherein the rotor modules (2a-2f) for each pole have a magnet component (3a-3f; 3a-3h), and magnet components (3a-3f; 3a-3h) which embody the same pole form a corresponding magnet component arrangement (4a, 4b, 4f),
wherein the first to Nth rotor module (2a-2f) are arranged in ascending sequence of their designation in the axial direction,
wherein each magnet component (3a-3f; 3a-3h), belonging to one of the magnet component arrangements (4a), of the first to Nth rotor module (2a-2f) is arranged in each case at a stagger angle α₁ . . . α_{N} in the circumferential direction,
wherein the stagger angles αᵢ for 1≤i≤N/2 have a value αᵢ=α₀+k·β where 0≤k≤[(N/2)−1], α₀ is a fixed angular position in the circumferential direction, β is a fixed offset angle, and all the stagger angles αᵢ are different from one another,
wherein the stagger angles αₘ for [(N/2)+1]≤m≤N have a value αₘ=α_{N-m+1}, characterized in that,
   the stagger angle αᵢ of at least two of the magnet components (3b) belonging to the magnet component arrangement (4a) is unequal to α₀+(i−1)·β,

The present invention relates to a rotor for an electric machine which has at least two poles and an even number of N≥6 stacked rotor modules, wherein the rotor modules for each pole have a magnet component, and magnet components which embody the same pole form a corresponding magnet component arrangement, wherein the first to Nth rotor module are arranged in ascending sequence of their designation in the axial direction, wherein each magnet component, belonging to one of the magnet component arrangements, of the first to Nth rotor module is arranged in each case at a stagger angle α₁ . . . α_{N} in the circumferential direction, wherein the stagger angles αᵢ for 1≤i≤N/2 have a value αᵢ=α₀+k·β where 0≤k≤[(N/2)−1], α₀ is a fixed angular position in the circumferential direction, β is a fixed offset angle, and all the stagger angles αᵢ are different from one another, wherein the stagger angles αₘ for [(N/2)+1]≤m≤N have a value αₘ=α_{N-m+1}.

In addition, the invention relates to an electric machine.

Stacked rotors, in which the poles do not extend continuously in a straight line in the axial direction, are used to reduce Gagging torques and a torque ripple during operation of an electric machine.

Document DE 10 2012 205 191 A1 discloses, for example, a rotor with an arrangement of six pole components, which are arranged in a layer direction running perpendicularly to the rotation direction. There is an offset between a first pole component and a second pole component and also between a third pole component and a second pole component. A fourth pole component does not have an offset in relation to the third pole component. A fifth pole component and a sixth pole component each have an offset to their predecessor in the opposite direction.

Such a symmetrical V-shaped arrangement makes it possible to balance out axial forces on the first to third rotor module that arise during rotary operation of the rotor by way of axial forces on the fourth to sixth rotor module that have practically the same values as the first-mentioned axial forces, but are oriented oppositely thereto. This leads, however, to a measurable axial deformation of the rotor, which may cause vibrations and oscillations. In an unfavourable scenario, the axial force can be transferred to a stator, so that a natural frequency of the stator is excited, which is undesirable in particular from NVH perspectives (noise, vibration, harshness).

The object of the invention is consequently to describe a way of operating an electric machine in an improved manner as considered from NVH perspectives.

To solve this problem, it is provided in accordance with the invention in a rotor of the kind described at the outset that the stagger angle c of at least two of the magnet components belonging to the magnet component arrangement is unequal to α₀+(i−1)·β.

The magnet components belonging to the magnet component arrangements are each arranged at a stagger angle α₁ . . . α_{N}, which is a central angle in a cylindrical coordinate system. The coordinate system is identical here for all other stagger angles. Each stagger angle is based here on a specified point of a magnet component, which is the same for all magnet components. For example, in the case of plate-like magnet components this can be the centerpoint of the component, at which the angle can be positioned perpendicularly.

The stagger angles ai are based here on the magnet components, belonging to the magnet component arrangement, of the first to (N/2)th rotor module. These magnet components are also referred to hereinafter as the first group. Since the stagger angles ai are different from one another, each magnet component of the first group has a different stagger angle. In other words, no stagger angle occurs more than once in the first group.

The stagger angles αₘ are based on the magnet components, belonging to the magnet component arrangement, of the first to [(N/2)+1]th to Nth rotor module. These magnet components are also referred to hereinafter as the second group, The following applies for this: αₘ=α_{N-m+1}. This means that the second group is arranged mirror-symmetrically to the first group, with respect to a plane of symmetry that is perpendicular to the axis of the coordinate system and runs between the (N/2)th and [(N/2)+1]th rotor module.

The rotor according to the invention is characterized in that the stagger angle a of at least two of the magnet components belonging to the magnet component arrangement is unequal to α₀+(i−1)·β. This means that the first group and, due to the mirror-symmetrical arrangement, also the second group have at least one offset in the circumferential direction. In other words, at least one pair of stagger angles of the first group are swapped in comparison with stagger angles of a V-shaped arrangement (not according to the invention), in which the magnet components of the first group are in each case offset by a fixed angle from the preceding magnet component. Due to the mirror-symmetrical arrangement, in the rotor according to the invention reference can be made to a M-shaped, W-shaped or zigzagged arrangement of the magnet components belonging to the magnet component arrangement.

In the rotor according to the invention, axial forces oriented oppositely are created within the first to (N/2)th rotor module during rotary operation, whereas in the V-shaped arrangement the axial forces within the first to (N/2)th rotor module and the [(N/2)+1]th to Nth rotor module are oriented uniformly. In the rotor according to the invention, an at least partial compensation of the axial forces thus occurs already within the first to (N/2)th rotor module on the one hand and the [(N/2)+1]th to Nth rotor module on the other hand, which advantageously has a favorable effect on the development of noises and vibrations in rotary operation.

Generally, N≤20, preferably N≤12, particularly preferably N≤10. The rotor according to the invention preferably has at least four, particularly preferably at least six, very particularly preferably at least eight poles. The poles or the magnet components of each rotor module or the magnet component arrangements are typically arranged equidistantly from one another in the circumferential direction. Generally, north poles or magnet component arrangements which embody a north pole radially outwardly alternate in the circumferential direction with south poles or magnet components arrangements which embody a south pole radially outwardly. Adjacent magnet component arrangements are typically free of overlaps. If, in the first magnet component arrangement, α_{1,n}=αₙ where 1≤n≤N, and α_{2,n} . . . α_{P,n} for 2≤p≤P are in each case a stagger angle of a magnet component, belonging to the pth magnet component arrangement, of the nth rotor module, wherein P is the number of poles, this thus typically results in α_{P,n}=αₙ+[(p−1)·2π/P].

In a preferred embodiment it is provided that the stagger angle αᵢ of at least three of the magnet components belonging to the magnet component arrangement is unequal to α₀+(i−1)·β. It is also conceivable that the stagger angle αᵢ of all magnet components, belonging to the magnet component arrangement, of the first to (N/2)th rotor module is unequal to α₀+(i−1)·β.

In the rotor according to the invention it can be provided that the offset angle as viewed from an output side of the rotor is positive in the clockwise direction. Alternatively, the offset angle as viewed from an output side of the rotor is negative in the clockwise direction.

In preferred embodiments of the rotor according to the invention α₁=α₀. In other words, the magnet component, belonging to the magnet component arrangement, of the first rotor module is located at an edge position in the circumferential direction.

A particularly simple embodiment of the rotor according to the invention is provided if N=6. Here, however, only a M-shaped or W-shaped arrangement can be realized, In this case, more specifically, the following embodiments of the rotor, specified in the rows of the following table, are preferred:

| α₁ = α₀+ | α₂ = α₀+ | α₃ = α₀+ |
|---|---|---|
| 0 | 2 · β | β |
| β | 0 | 2 · β |
| 2 · β | 0 | β |
| β | 2 · β | 0 |

Of these, it is particularly preferred if α₂=α₀+2·β and α₃=α₀+β.

Generally, for more complex rotors, it can be provided that N≥8. A good compromise between the complexity of the rotor and the possibility to amend the distribution of the axial forces is provided if N=8.

In a rotor with eight rotor modules, each of the following embodiments is possible:

| α₁ = α₀+ | α₂ = α₀+ | α₃ = α₀+ | α₄ = α₀+ |
|---|---|---|---|
| 0 | β | 3 · β | 2 · β |
| 0 | 2 · β | β | 3 · β |
| 0 | 2 · β | 3 · β | β |
| 0 | 3 · β | β | 2 · β |
| 0 | 3 · β | 2 · β | β |
| β | 0 | 2 · β | 3 · β |
| β | 0 | 3 · β | 2 · β |
| 2 · β | 0 | β | 3 · β |
| 2 · β | 0 | 3 · β | β |
| 3 · β | 0 | β | 2 · β |
| 3 · β | 0 | 2 · β | β |
| β | 2 · β | 0 | 3 · β |
| β | 3 · β | 0 | 2 · β |
| 2 · β | β | 0 | 3 · β |
| 2 · β | 3 · β | 0 | β |
| 3 · β | β | 0 | 2 · β |
| 3 · β | 2 · β | 0 | β |
| β | 2 · β | 3 · β | 0 |
| β | 3 · β | 2 · β | 0 |
| 2 · β | β | 3 · β | 0 |
| 2 · β | 3 · β | β | 0 |
| 3 · β | β | 2 · β | 0 |

As particularly preferred embodiments for α₁=α₀, the following are noted
α₂=α₀+β and α₃=α₀+3·β and α₄=α₀+2·β or
α₂=α₀+3·β and α₃=α₀+2·β and α₄=α₀+β or
α₂=α₀+3·β and α₃=α₀+β and α₄=α₀+2·β.

A particularly balanced force distribution with N greater than or equal to 8 results if, for each arrangement of [(N/2)−1] successive rotor modules of the first to (N/2)th rotor module, at most [(N/2)−3] pair or pairs of directly adjacent magnet components of the magnet component arrangement are offset from one another by the single the offset angle.

In the rotor according to the invention it is expediently provided that the axial width of each rotor module is at least 5 mm, preferably at least 10 mm, particularly preferably at least 15 mm and/or at most 45 mm, preferably at most 35 mm, particularly preferably at most 30 mm.

In addition, in the rotor according to the invention, it can be provided that each rotor module has a partial laminated core, in which the magnet components are arranged, in particular embedded or surface-mounted. The partial laminated cores typically embody a cohesive rotor laminated core.

The rotor can also have a shaft.

The object on which the invention is based is furthermore achieved by an electric machine comprising a stator and a rotor according to the invention which is arranged inside the stator.

It can be provided here that the stator has a plurality of stator teeth. The stator teeth are preferably each distanced from one another by a tooth angle, wherein the offset angle β is a positive integer multiple of the tooth angle. Alternatively or additionally, the stator teeth can run in a straight line in the axial direction.

Further advantages and details of the present invention emerge from the drawings described hereinafter: These are schematic illustrations and show:

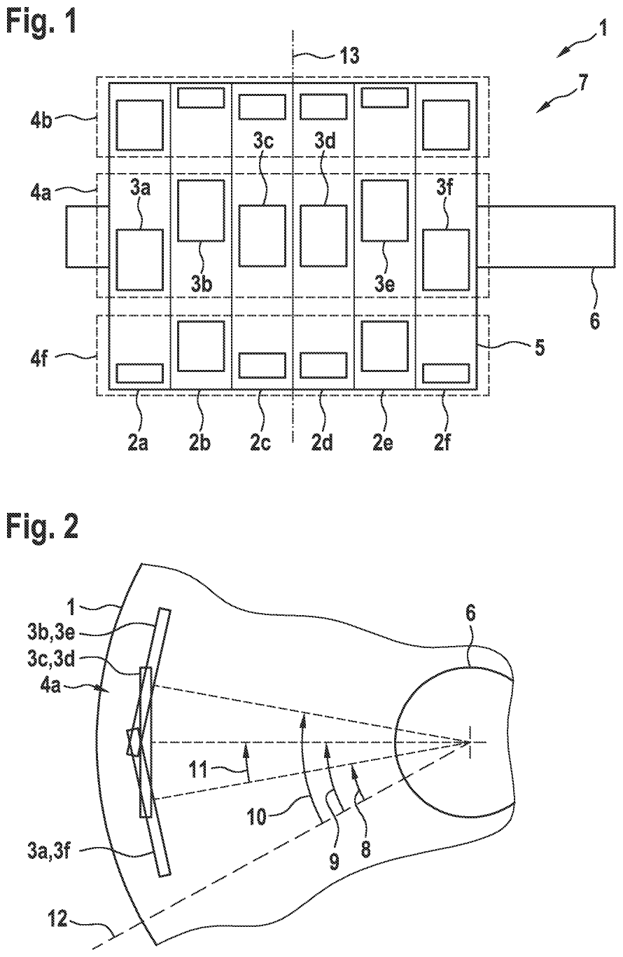

FIG. 1 a side view of a first exemplary embodiment of th otor according to the invention;

FIG. 2 a cutaway detail view of the rotor shown in FIG. 1;

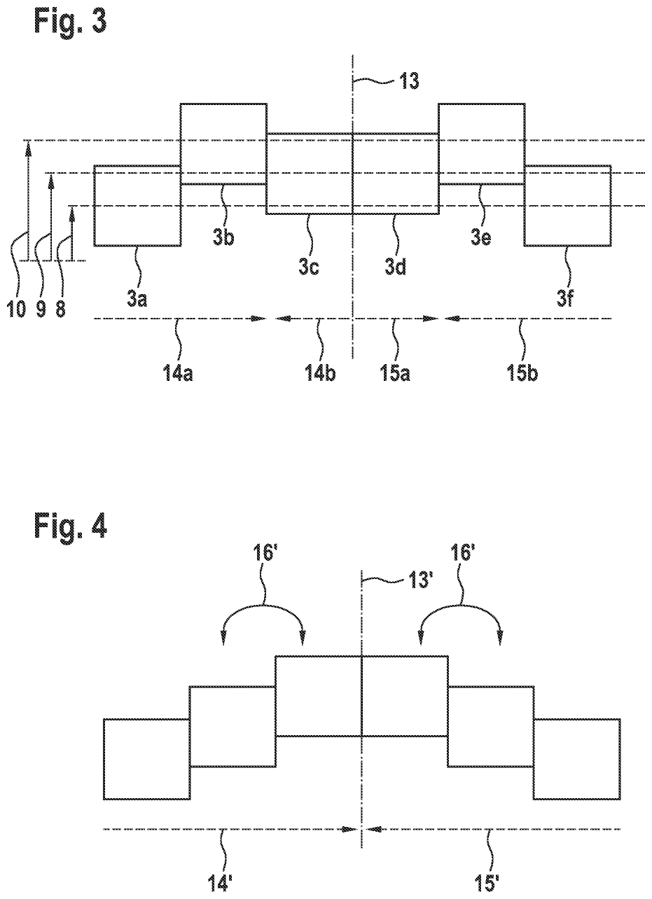

FIG. 3 a stagger schema with indicated axial forces of the rotor shown in FIG. 1;

FIG. 4 a stagger schema with indicated axial forces of a rotor according to the prior art;

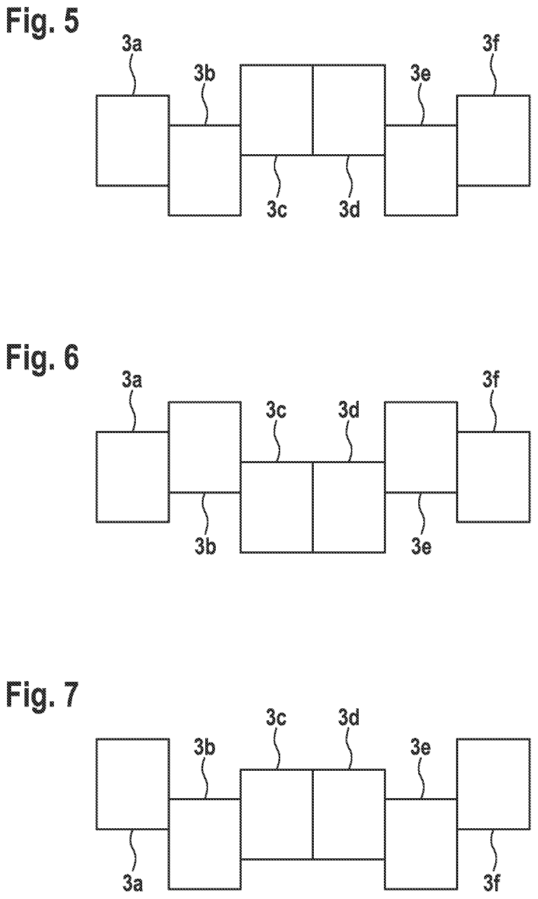

FIGS. 5 to 7 each show a stagger schema of a further exemplary embodiment of the rotor according to the invention with N=6;

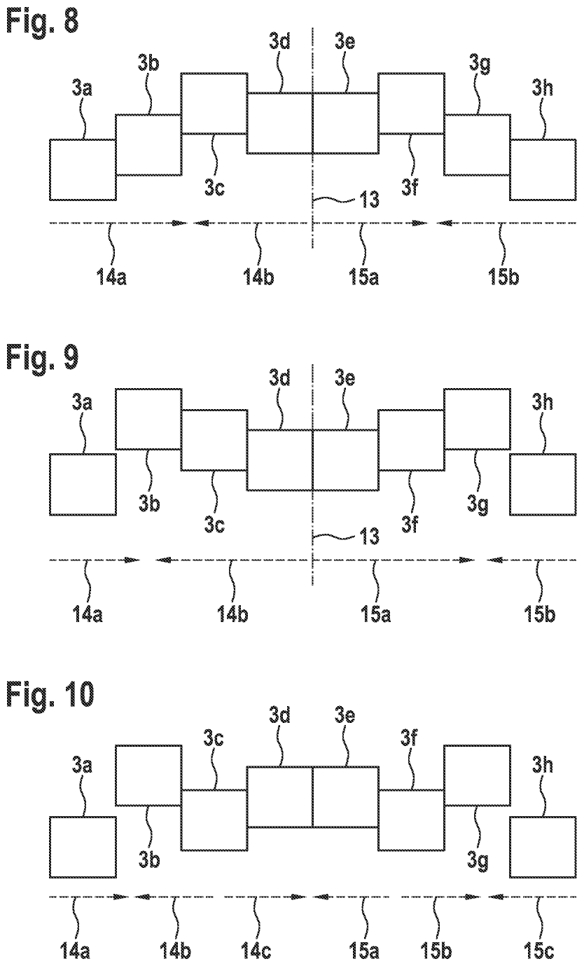

FIGS. 8 to 10 each show a stagger schema with indicated axial forces of a further exemplary embodiment of the rotor according to the invention with N=8;

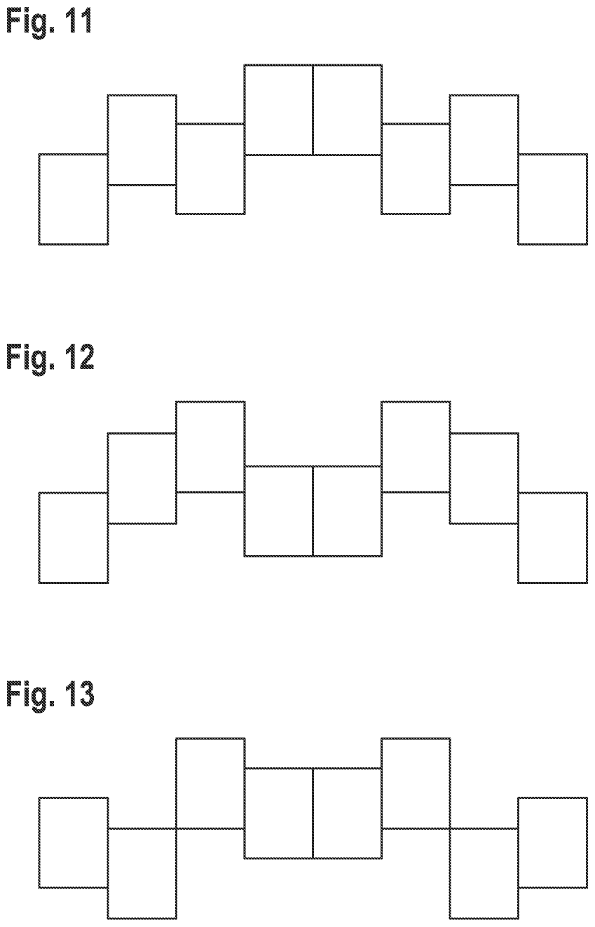

FIGS. 11 to 29 each show a stagger schema of a further exemplary embodiment of the rotor according to the invention with N=8;

FIG. 30 shows a basic diagram of an exemplary embodiment of the electric machine according to the invention.

FIG. 1 is a side view of a first exemplary embodiment of a rotor 1.

The rotor in the present exemplary embodiment has, by way of example, P=6 poles and an even number of N=6 stacked rotor modules 2a to 2f. For each pole of the rotor 1, each rotor module 2a to 2f has a magnet component, wherein magnet components of the rotor modules 2a to 2f embodying the same pole form a magnet component arrangement 4a, 4b, 4f. For reasons of clarity, only one magnet component 3a of the first rotor module 2a, one magnet component 3b of the second rotor module 2b, one magnet component 3c of the third rotor module 2c, one magnet component 3d of the fourth rotor module 2d, one magnet component 3e of the fifth rotor module 2e, and one magnet component 3f of a sixth rotor module 2f, which together form a first magnet component arrangement 4a, have been provided with reference signs in FIG. 1. It can be seen that the first to sixth rotor module 2a to 2f are arranged in ascending sequence of their designation in the axial direction.

In addition, FIG. 1 shows a second magnet component arrangement 4b and a sixth magnet component arrangement 4f, wherein a third, a fourth and a fifth magnet component arrangement are disposed on a rear side of the rotor 1, which is hidden in FIG. 1. Here, merely by way of example, the magnet components 3a to 3f of the first magnet component arrangement 4a, the magnet components of the third magnet component arrangement, and the magnet components of the fifth magnet component arrangement each embody a north pole radially outwardly, whereas the magnet components of the second magnet component arrangement 4b, the magnet components of the fourth magnet component arrangement, and the magnet components of the sixth magnet component arrangement 4f each embody a south pole radially outwardly.

The magnet components 3a to 3f and the other magnet components are embodied as plate-like permanent magnets embedded in a laminated core 5 of the rotor 1 and are visible in FIG. 1. The rotor 1 also has a shaft 6.

FIG. 2 is a cutaway detail view of the rotor 1 as viewed from an output side 7 (see FIG. 1). Here, FIG. 2 shows a sector-like detail in the region of the first magnet component arrangement 4a, showing projections of the magnet components 3a to 3f.

The magnet components 3a to 3f belonging to the first magnet component arrangement 4a are each arranged at a stagger angle α₁ . . . α_{N} in the circumferential direction. FIG. 2 also shows three, in the circumferential direction, positive angles 8, 9, 10 in relation to a reference angle position 12. The angle 8 in this case designates the stagger angles α₁, α₆, at which the magnet components 3a and 3f are arranged, the angle 9 designates the stagger angles α₃, α₄, at which the magnet components 3c, 3d are arranged, and the angle 10 designates the stagger angles α₂, α₅, at which the magnet components 3b, 3e are arranged. Here, the stagger angles α₃, α₄ are greater than the stagger angles α₁, α₆ by an offset angle β, shown by an angle 11, and the stagger angles α₂, α₅ are greater than the aforesaid stagger angles α₁, α₆ by twice the offset angle β. Expressed as a formula, the following is true: α₁=α₀ and α₂=α₀+2·β and β₃=α₀+β, wherein as describes an edge position in the circumferential direction of the magnet component, here the magnet component 3a, having the smallest angular value.

Consequently, the stagger angles αᵢ for 1≤i≤3 have a value αᵢ=α₀+k·β where 0≤k≤2. The stagger angles am for 4≤m≤6 have a value αₘ=α₇₋ₘ, whereby they are distributed mirror-symmetrically in relation to a plane of symmetry 13 (see FIG. 1). In this respect, the first three or N/2 magnet components 3a, 3b, 3c on one side of the plane of symmetry 13 can also be designated as the first group, and the last three or N/2 magnet components 3d, 3e, 3f on the other side of the plane of symmetry 13 can also be designated as the second group.

Evidently, it is true for the magnet components 3a, 3b, 3c belonging to the first magnet component arrangement 4a that the stagger angles are α₂=α₀+2·β≠α₀+(2−1)·β and α₃=α₀+β≠α₀+(3−1). An offset in the arrangement of the magnet components 3a to 3c is thus realized, and, due to the mirror-symmetrical arrangement, is also realized in the arrangement of the magnet components 3d to 3f.

Generally speaking, it is true for the first magnet component arrangement 4a that the stagger angles αᵢ for 1≤i≤N/2 have a value αᵢ=α₀+k·β where 0≤k≤[(N/2)−1] and all stagger angles αᵢ are different from one another, that the stagger angles αₘ for [(N/2)+1]≤m≤N have a value αₘ=α_{N-m+1}, and that the stagger angle αᵢ of at least one of the magnet components 3b, 3c belonging to the magnet component arrangement is unequal to α₀+(i−1)·β.

Again with reference to FIG. 1, the offset results in the clearly visible M-shaped arrangement of the magnet components 3a to 3f. For the rest of the magnet component arrangements 4b, 4f, the corresponding magnet components are arranged similarly thereto. The individual stagger angles of the magnet components of the other magnet component arrangements 4b, 4f are offset here by 60° or generally by 360°/P in the circumferential direction in relation to the preceding magnet component arrangement 4a, 4b.

FIG. 3 is a stagger schema of the rotor 1 with indicated axial forces during rotary operation of the rotor 1. A stagger schema illustrates here the position ratios of the magnet elements of a magnet component arrangement representative for the other magnet component arrangements in two-dimensional form. The offset angle β and axial distances of the magnet components are purely exemplary here. The multiples of the offset angle β of the individual magnet components are shown here in principle qualitatively by the stagger schema.

The axial forces effective during rotary operation are shown by arrows 14a, 14b, 15a, 15b. In this case, the arrows 14a, 14b relate to axial forces within the rotor modules 2a, 2b, 2c, which lie on the first side of the plane of symmetry 13, and the arrows 15a, 15b relate to axial forces within the rotor modules 2d, 2e, 2f, which lie on the other side of the plane of symmetry 13. The direction of the indicated axial forces is based here on an exemplary working point in rotary operation of the rotor 1. The direction of each indicated axial force can be reversed at other operating points, wherein, however, their arrangement relative to one another is maintained.

The mirror-symmetrical arrangement of the magnet components 3a to 3f firstly has the advantage that the axial forces cancel out one another over the entire length of the rotor 1. This is a significant advantage in view of NVH requirements. It can, however, also be seen that the axial forces represented by the arrows 14a, 14b on the one hand and the axial forces represented by the arrows 15a, 15b on the other hand compensate one another in part.

By way of comparison, FIG. 4 shows a stagger schema of a rotor according to the prior art with a V-shaped arrangement of magnet components. Visible here are axial forces shown by corresponding arrows 14′, 15′, specifically also of equal magnitude. However, there is no compensation within rotor modules on either side of the plane of symmetry 13′. In the rotor according to the prior art, an axial deformation, which may cause undesirable vibrations and noise and may transfer a standing wave to a stator, is much greater than in the rotor 1 according to the first exemplary embodiment.

In FIG. 4, double arrows 16′ additional signify that the condition according to which the stagger angle ai of at least two of the magnet components belonging to the magnet component arrangement is unequal to α₀+(i−1)·β can be interpreted in this and the following exemplary embodiments as a swapping of the stagger angles of two magnet components.

FIGS. 5 to 7 each show a stagger schema of a further exemplary embodiment of a rotor with N=6.

For the stagger angles α₁, α₂, α₃, the following is true in each case:

| | α₁ = α₀+ | α₂ = α₀+ | α₃ = α₀+ |
|---|---|---|---|
| FIG. 5 | β | 0 | 2 · β |
| FIG. 6 | β | 2 · β | 0 |
| FIG. 7 | 2 · β | 0 | β |

Due to the mirror symmetry, the further stagger angles can α₄, α₅, α₆ of course be determined therefrom similarly. Consequently, the exemplary embodiments according to FIG. 5 and FIG. 7 can be interpreted as a W-shaped arrangement and the exemplary embodiment according to FIG. 6 can be interpreted as a M-shaped arrangement.

FIGS. 8 to 29 each show a stagger schema of a further exemplary embodiment of a rotor with N=8, wherein in FIG. 8 to FIG. 10 axial forces corresponding to FIG. 3 are additionally indicated, In these exemplary embodiments, a seventh and eighth rotor module are of course provided. Furthermore, the first group of magnet components 3a to 3d has stagger angles α₁, α₂, α₃, α₄ and the second group of magnet components 3e to 3h has stagger angles α₅, α₆, α₇, α₈. The other statements provided for the first exemplary embodiment apply for the exemplary embodiments with N=8 accordingly, provided nothing to the contrary is described hereinafter.

In the exemplary embodiment according to FIG. 8, it is true that α₁=α₀, α₂=α₀+β, α₃=α₀+3·β and α₄=α₀+2·β. As can be seen, the axial forces represented by the arrows 14a, 14b on the one hand and the axial forces represented by the arrows 15a, 15b advantageously cancel out one another on each side of the plane of symmetry 13. Again, a M-shaped arrangement is provided.

In the exemplary embodiment according to FIG. 9, it is true that α₁=α₀, α₂=α₀+3·β and α₃=α₀+2β and α₄=α₀+β. As can be seen, the axial forces represented by the arrows 14a, 14b on the one hand and the axial forces represented by the arrows 15a, 15b advantageously cancel out one another in part on each side of the plane of symmetry 13. Again, a M-shaped arrangement is provided.

In the exemplary embodiment according to FIG. 10, it is true that α₁=α₀, α₂=α₀+3·β, α₃=α₀+β and α₄=α₀+2·β. As can be seen, the axial forces represented by the arrows 14a, 14b, 14c on the one hand and the axial forces represented by the arrows 15a, 15b, 15c advantageously cancel out one another in part on each side of the plane of symmetry 13. This arrangement can be interpreted as being zigzagged.

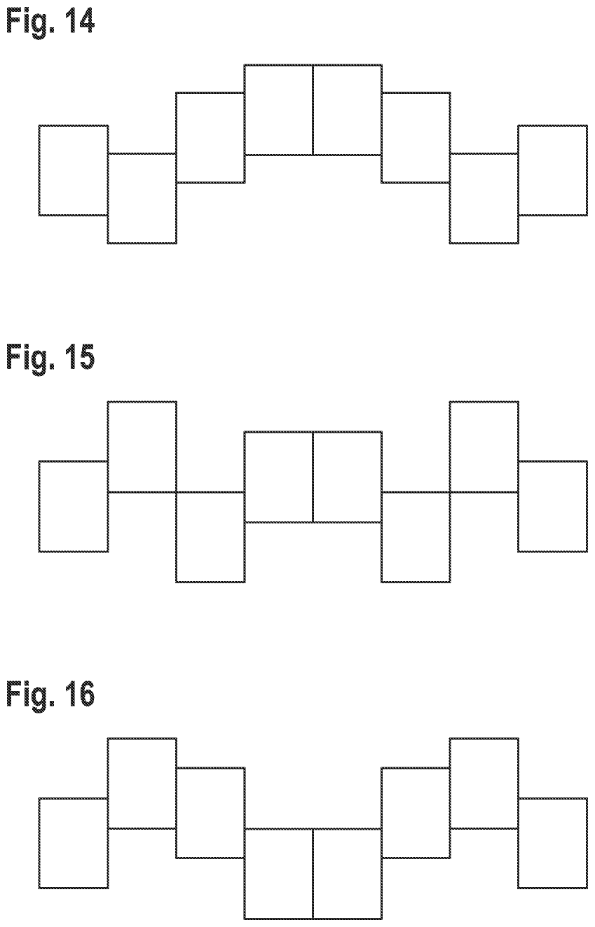

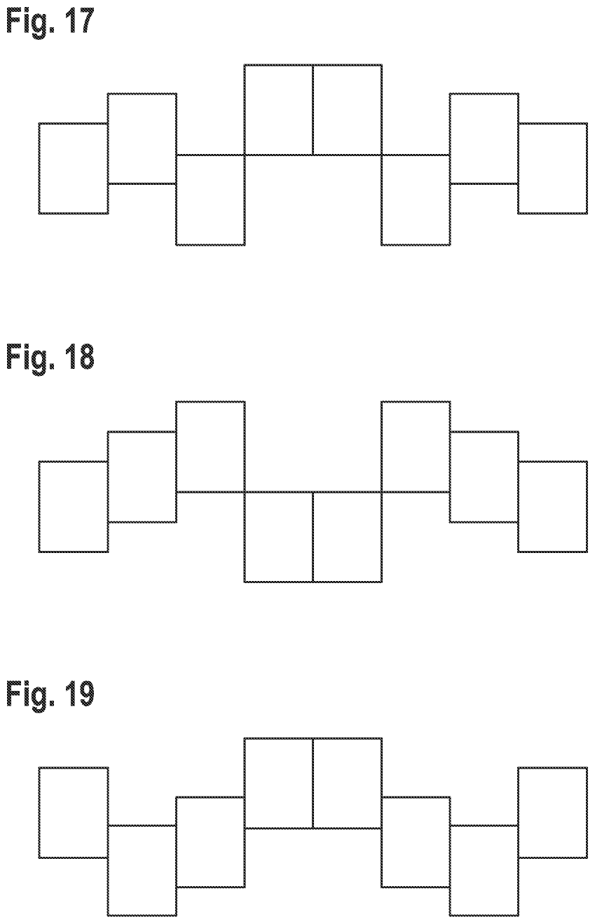

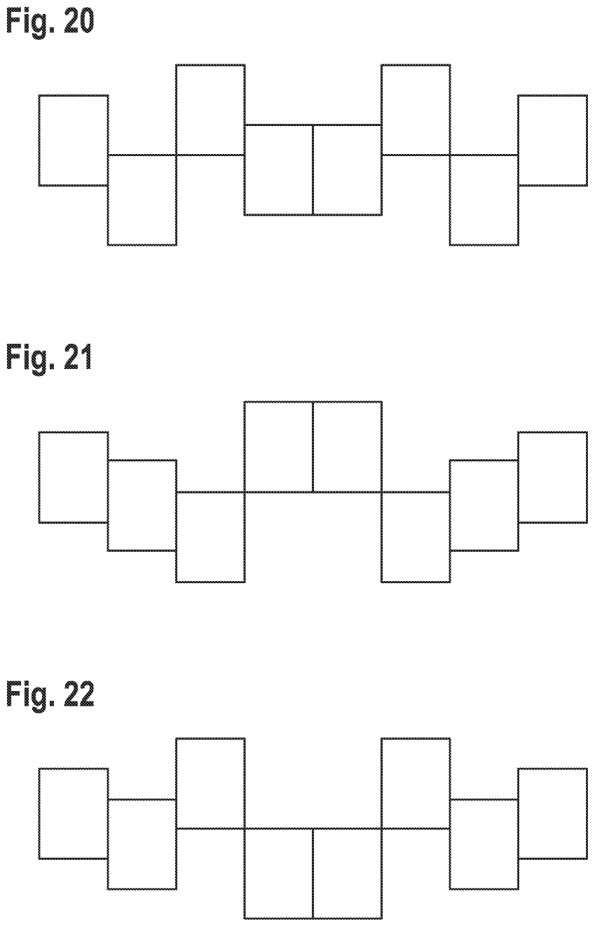

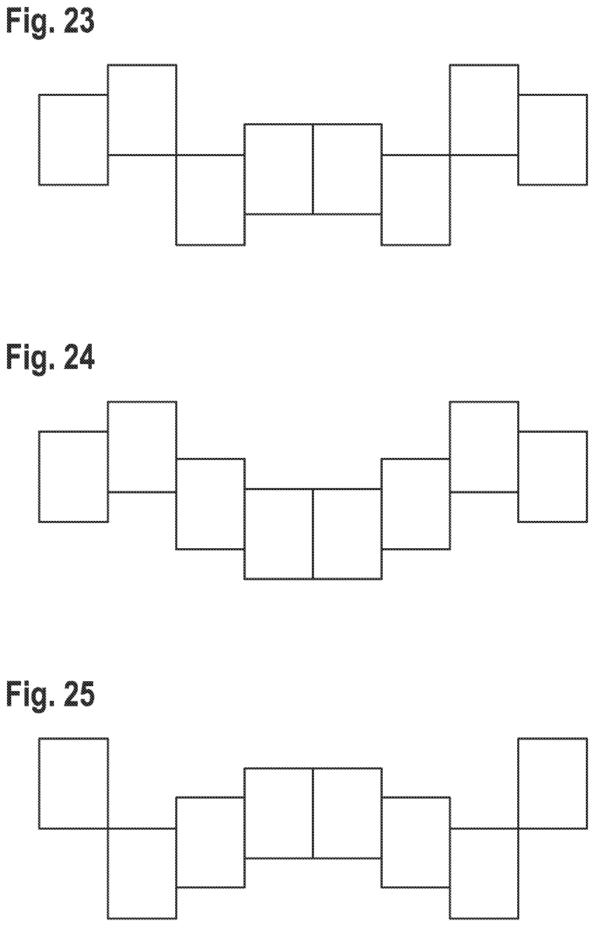

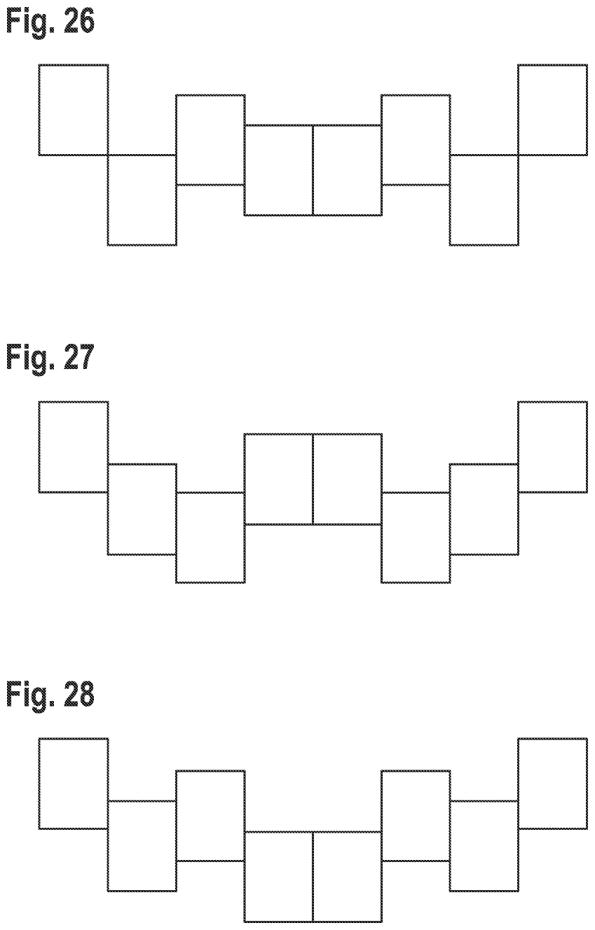

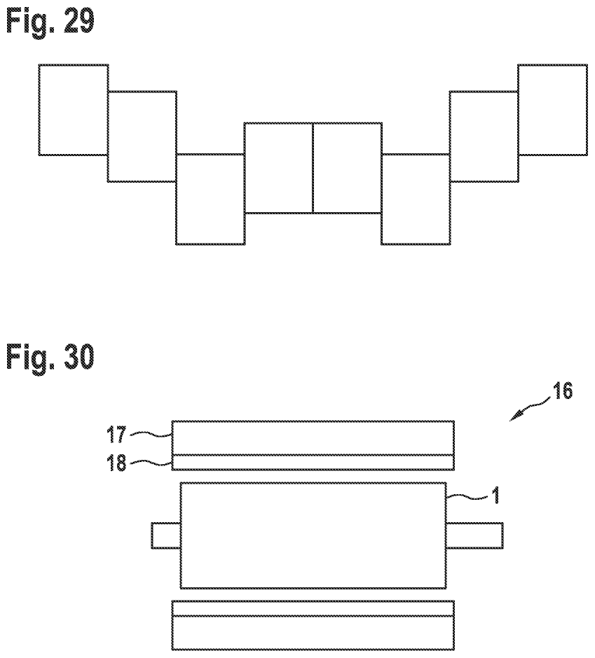

In the exemplary embodiments according to FIG. 11 to FIG. 29, the indication of the reference signs 3a to 3f and 13 has been omitted for reasons of clarity. Here, more specifically, the following is true for the stagger angles α₁, α₂, α₃, α₄:

| | α₁ = α₀+ | α₂ = α₀+ | α₃ = α₀+ | α₄ = α₀+ |
|---|---|---|---|---|
| FIG. 11 | 0 | 2 · β | β | 3 · β |
| FIG. 12 | 0 | 2 · β | 3 · β | β |
| FIG. 13 | β | 0 | 3 · β | 2 · β |
| FIG. 14 | β | 0 | 2 · β | 3 · β |
| FIG. 15 | β | 3 · β | 0 | 2 · β |
| FIG. 16 | β | 3 · β | 2 · β | 0 |
| FIG. 17 | β | 2 · β | 0 | 3 · β |
| FIG. 18 | β | 2 · β | 3 · β | 0 |
| FIG. 19 | 2 · β | 0 | β | 3 · β |
| FIG. 20 | 2 · β | 0 | 3 · β | β |
| FIG. 21 | 2 · β | β | 0 | 3 · β |
| FIG. 22 | 2 · β | β | 3 · β | 0 |
| FIG. 23 | 2 · β | 3 · β | 0 | β |
| FIG. 24 | 2 · β | 3 · β | β | 0 |
| FIG. 25 | 3 · β | 0 | β | 2 · β |
| FIG. 26 | 3 · β | 0 | 2 · β | β |
| FIG. 27 | 3 · β | β | 0 | 2 · β |
| FIG. 28 | 3 · β | β | 2 · β | 0 |
| FIG. 29 | 3 · β | 2 · β | 0 | β |

According to further exemplary embodiments of a rotor which, for the rest, correspond to one of the previously described exemplary embodiments, the magnet components are embodied as surface-mounted permanent magnets.

FIG. 30 is a basic diagram of an exemplary embodiment of an electric machine 16.

The electric machine 16 comprises a stator 17 with stator grooves or stator teeth 18. Typically, the stator grooves or stator teeth are straight in the axial direction. A rotor 1 according to one of the previously described exemplary embodiments is arranged rotatably inside the stator 17. The stator teeth 18 are preferably each distanced from one another by a tooth angle, wherein the offset angle β is a positive integer multiple of the tooth angle,

The electric machine 16 is designed to drive a vehicle, for example an electric vehicle or a hybrid vehicle.

1. A rotor for an electric machine comprising: at least two poles; and
an even number of N≥6 stacked rotor modules for each of the at least two poles, wherein the rotor modules for each pole have a magnet component, and magnet components which embody the same pole form a corresponding magnet component arrangement,
wherein the first to Nth rotor module are arranged in ascending sequence of their designation in the axial direction,
wherein each magnet component, belonging to one of the magnet component arrangements, of the first to Nth rotor module is arranged in each case at a stagger angle α₁ . . . α_{N} in the circumferential direction,
wherein the stagger angles αᵢ for 1≤i≤N/2 have a value αᵢ=α₀+k·β where 0≤k≤[(N/2)−1], α₀ is a fixed angular position in the circumferential direction, β is a fixed offset angle, and all the stagger angles αᵢ are different from one another,
wherein the stagger angles αₘ for [(N/2)+1]≤m≤N have a value αₘ=α_{N-m+1}, the stagger angle αᵢ of at least three of the magnet components belonging to the magnet component arrangement is unequal to α₀+(i−1)·β.

2. The rotor as claimed in claim 1, wherein the offset angle β is positive or negative in the clockwise direction as viewed from an output side of the rotor.

3. The rotor as claimed in claim 1, wherein α₁=α₀.

4. The rotor as claimed in claim 3, wherein N=6.

5. The rotor as claimed in claim 4, wherein α₂=α₀+2·β and α₃=α₀+β.

6. The rotor as claimed in claim 3, wherein N≥8.

7. The rotor as claimed in claim 6, wherein N=8.

8. The rotor as claimed in claim 7, wherein α₂=α₀+β and α₃=α₀+3·β and α₄=α₀+2·β.

9. The rotor as claimed in claim 7, wherein α₂=α₀+3·β and α₃=α₀+2·β and α₄=α₀+β.

10. The rotor as claimed in claim 7, wherein α₂=α₀+3·β and α₃=α₀+β and α₄=α₀+2·β.

11. The rotor as claimed in claim 6, wherein for each arrangement of [(N/2)−1] successive rotor modules (3a-3f; 3a-3h) of the first to (N/2)th rotor module (2a, 2b, 2c), at most [(N/2)−3] pair or pairs of directly adjacent magnet components (3a-3f; 3a-3h) of the magnet component arrangement are offset from one another by the single offset angle β.

12. The rotor as claimed in claim 1, wherein the axial width of each rotor module is at most 30 mm.

13. An electric machine, comprising: a stator; and a rotor as claimed in claim 1 inside the stator.

14. The electric machine as claimed in claim 13, wherein the stator has a plurality of stator teeth, which are each distanced from one another by a tooth angle, wherein the offset angle β is a positive integer multiple of the tooth angle.
